(19) United States
(12) Patent Application Publication
(10) Pub. No.: US 2012/0284543 A1
(43) Pub. Date: Nov. 8, 2012

(54) USER INPUT TRIGGERED DEVICE POWER MANAGEMENT

(75) Inventors: Changjiu Xian, Sammamish, WA (US); Bruce L. Worthington, Redmond, WA (US)

(73) Assignee: MICROSOFT CORPORATION, Redmond, WA (US)

(21) Appl. No.: 13/099,077

(22) Filed: May 2, 2011

(51) Int. Cl. G06F 1/32; G06F 1/00

(52) U.S. Cl. 713/320; 713/300; 713/340

(57) ABSTRACT

Techniques for user input triggered device power management are described that enable user inputs and activities to cause selective changes in power states for a device. Power can be boosted to a high power state to improve responsiveness for designated inputs and/or activities. When responsiveness is deemed less important in connection with particular inputs and/or activities, a low power state can be set to reduce energy consumption. In at least some embodiments, selectively switching between power states includes detecting various user inputs at a device and filtering the inputs to select power states associated with the user inputs. The device can then be operated in a selected power state until a transition to a different power state is triggered by occurrence of designated events, such as running of a set time interval, further user input, and/or completion of user activity.

### BACKGROUND

There is an inherent tradeoff between energy consumption and responsiveness in computer systems, particularly in situations where a user is actively waiting on the computer to perform some activity. By running in a higher energy-consumptive state (e.g., by running one or more components of a computing system in such states), operations may be completed faster and user-perceived responsiveness can be improved. Conversely, running the system in lower energy-consumptive states may reduce responsiveness. Existing power management algorithms for computing system, however, do not differentiate sufficiently between types of activity (e.g., user inputs) to enable informed decisions to be made to balance responsiveness and energy consumption.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for user input triggered device power management are described that enable user inputs and activities to cause selective changes in power states for a device. Power can be boosted to a high power state to improve responsiveness for designated inputs and/or activities. When responsiveness is deemed less important in connection with particular inputs and/or activities, a low power state can be set to reduce energy consumption. In at least some embodiments, selectively switching between power states includes detecting various user inputs at a device and filtering the inputs to select power states associated with the user inputs. The device can then be operated in a selected power state until a transition to a different power state is triggered by occurrence of designated events, such as running of a set time interval, further user input, and/or completion of user activity.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 is a diagram showing components of an example power manager module in accordance with one or more embodiments.

FIG. 3 is a flow diagram that describes steps of an example method in accordance with one or more embodiments.

FIG. 4 is a flow diagram that describes steps of another example method in accordance with one or more embodiments.

FIG. 5 is a flow diagram that describes steps of another example method in accordance with one or more embodiments.

FIG. 6 illustrates an example computing system that can be used to implement one or more embodiments.

### DETAILED DESCRIPTION

### Overview

Techniques for user input triggered device power management are described that enable user inputs and activities to cause selective changes in power states for a device. Power can be boosted to a high power state to improve responsiveness for designated inputs and/or activities. When responsiveness is deemed less important in connection with particular inputs and/or activities, a low power state can be set to reduce energy consumption. In at least some embodiments, selectively switching between power states includes detecting various user inputs at a device and filtering the inputs to select power states associated with the user inputs. The device can then be operated in a selected power state until a transition to a different power state is triggered by occurrence of designated events, such as running of a set time interval, further user input, and/or completion of user activity.

In the discussion that follows, a section titled “Operating Environment” is provided and describes one environment in which one or more embodiments can be employed. Following this, a section titled “User Input Triggered Device Power Management Techniques” describes example techniques and methods in accordance with one or more embodiments. This section includes several subsections that describe example implementation details regarding “Filtering Inputs,” “Responding to Triggered States,” and “Transitioning out of a Triggered State.” Last, a section titled “Example System” describes example computing systems and devices that can be utilized to implement one or more embodiments.

Operating Environment

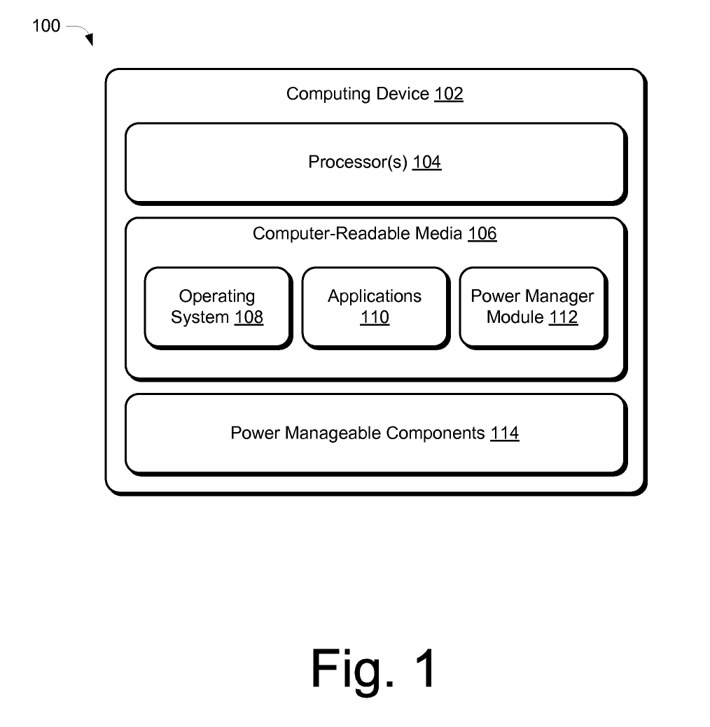

FIG. 1 illustrates an operating environment in accordance with one or more embodiments, generally at 100. Environment 100 includes a computing device 102 having one or more processors 104, one or more computer-readable media 106, an operating system 108, and one or more applications 110 that reside on the computer-readable media and which are executable by the processor(s). The one or more processors 104 may retrieve and execute computer-program instructions from applications 110 to provide a wide range of functionality to the computing device 102, including but not limited to office productivity, email, media management, printing, networking, web-browsing, and so forth. A variety of data and program files related to the applications 110 can also be included, examples of which include office documents, multimedia files, emails, data files, web pages, user profile and/or preference data, and so forth.

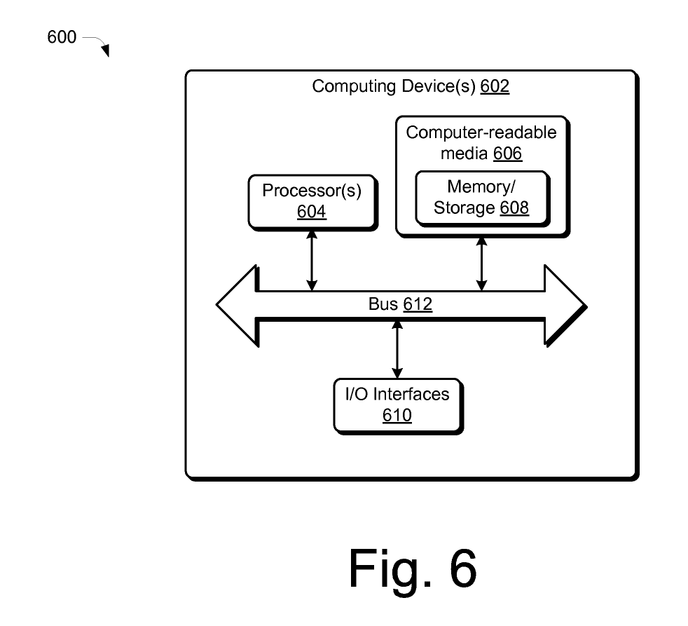

The computing device 102 can be embodied as any suitable computing system and/or device such as, by way of example and not limitation, a desktop computer, a portable computer, as tablet or slate computer, a handheld computer such as a personal digital assistant (PDA), a cell phone, a set-top box, and the like. One example of a computing system that can represent various systems and/or devices including the computing device 102 is shown and described below in FIG. 6.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 6.

The computing device 102 also includes a power manager module 112 that represents functionality operable to manage power and performance (e.g. responsiveness) for the computing device 102 in various ways. For instance, the power manager module 112 can implement various power management algorithms designed to manage, balance, and make energy consumption more efficient for one or more power manageable components 114. The power manager module 112 can be implemented as a standalone application as illustrated and/or as a component of another application, such as being an integrated component of the operating system 108.

The power manageable components 114 represent various components of a computing device 102 that can be transitioned between different power states available for the device and/or individual components. The power manager module 112 can therefore be configured to set the power states of different power manageable components 114 in response to various triggers. Examples of power manageable components 114 include but are not limited to the processors 104, memory, network cards, storage adapters, disk drives, optical drives, displays, chipsets, cameras, peripheral bus controllers (e.g., USB) and other power consuming components typically associated with a computing device.

In at least some embodiments, the power manager module 112 is configured to perform power management for the power manageable components 114 in response to user initiated triggers, such as various user inputs. In this approach, user inputs can be filtered and classified to match the inputs to corresponding power states. The user inputs can be detected by the power manager module 112 to trigger a switch to corresponding power states. For example, the power state can be boosted to a high power state when triggered by selected user inputs in order to improve responsiveness. More generally, higher power states that correspond to more energy consumption can be used when responsiveness is deemed relatively important, and lower power states can be used at other times. Transitioning between power states in this manner improves the user experience while still conserving energy and/or battery life when possible.

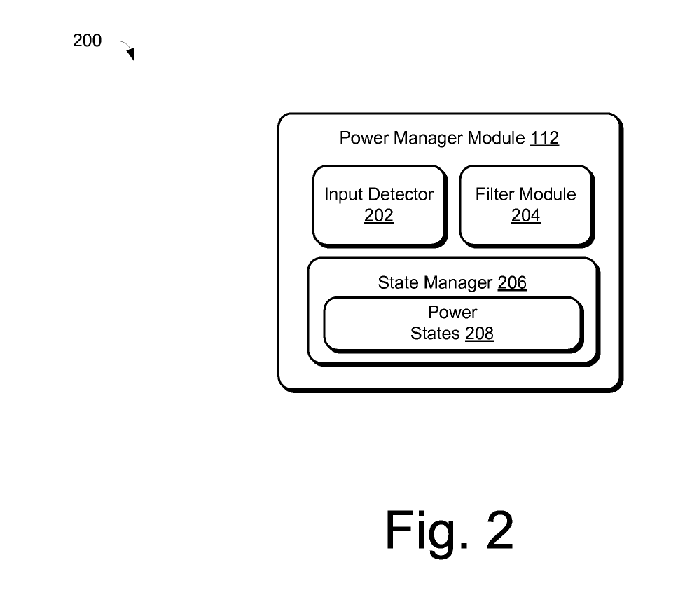

The power manager module 112 can be configured in various ways to implement the power management techniques described above and below. One particular example implementation of a power manager module 112 is shown in FIG. 2, generally at 200. The example power manager module 112 of FIG. 2 is depicted as including various sub-modules that represent logical divisions of the functionality that is represented by the power manager module 112. Naturally, any of the example modules and corresponding functionality described herein can be further divided or can be combined in various ways without departing from the spirit and scope of the described techniques.

In the depicted example, the power manager module 112 includes an input detector 202, a filter module 204, and a state manager 206. The input detector 202 represents functionality to detect various user inputs that can trigger power management. The input detector 202 can pass the user inputs to the filter module 204 for filtering. For example, the filter module 204 represents functionality to filter various inputs to categorize the inputs and/or match the inputs to corresponding power states. The filter module 204 can further operate to determine triggers that cause power management based on the filtering and invoke the state manager 206 to perform corresponding power management when appropriate.

The state manager 206 can operate to manage and control power states for various power manageable components 114 of the computing device 102. The state manager 206 can be configured to implement various power states 208. The state manager 206 can also handle transitions between the various power states 208. The power states 208 can represent individual states (e.g., component-specific states) that are associated with individual components. A selected power state can be applied to cause component-specific power state changes to one or more power manageable components. In addition, device-wide power states can also be defined to collectively set state levels and control power for multiple different components. A device-wide power state can be configured to encompass multiple component-specific states and power settings for multiple different devices. Thus, setting a low or high power state in response to a trigger at the device-wide level can cause corresponding power state changes for multiple components. On the other hand, triggers can also be configured to cause changes to component-specific states that can be applied directly to individual components.

Having described an example operating environment, consider now example techniques for user input triggered device power management in accordance with one or more embodiments.

User Input Triggered Device Power Management Techniques

The following section provides a discussion of flow diagrams that describe techniques for user input triggered device power management that can be implemented in accordance with one or more embodiments. In the course of describing the example methods, a number of subsections are provided that describe example implementation details for various aspects of user input triggered device power management. The example methods depicted can be implemented in connection with any suitable hardware, software, firmware, or combination thereof. In at least some embodiments, the methods can be implemented by way of a suitably configured computing device, such as the example computing device 102 of FIG. 1 that includes or otherwise makes use of a power manager module 112.

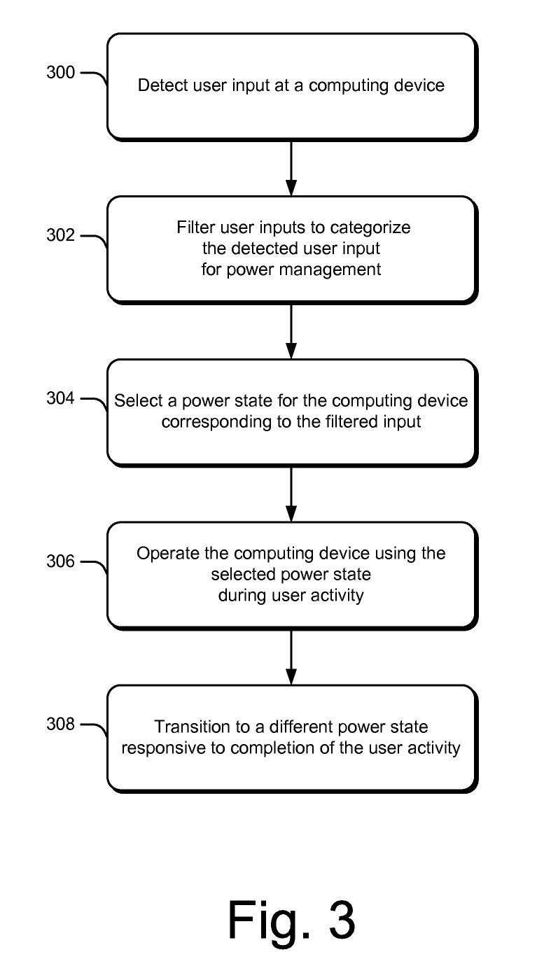

In particular, FIG. 3 depicts an example method in which user input can be employed to initiate power management operations for a computing device. Step 300 detects user input at a computing device. This step can be performed in any suitable way. For example, one way this can occur is through an input detector 202 provided by a power manager module 112. The input detector 202 can operate to detect various different kinds of input that can be associated with different components.

User inputs can be correlated to the start of particular user operations or activities (e.g., tasks, commands, or transactions) executed by the system. For instance, user inputs are frequently performed to start corresponding activities such as to launch an application, open a dialog, access the Internet, switch between programs, and so forth. At least some of these activities can be enhanced by boosting power to cause a corresponding increase in user perceived responsiveness of the system. Therefore, various triggering inputs and/or activities obtained from any suitable input device (e.g., hardware device inputs) can be detected to cause power management operations for a device. Triggers can also be generated via software that simulates device inputs. Further, inputs can include both locally and remotely generated inputs.

Software generated inputs can include, but are not limited to, remote/terminal user commands sent from a remote locations to the computing device, and other software-injected inputs. Hardware device inputs can include, but are not limited to mouse clicks, touchpad/trackball/trackpoint inputs and related button inputs, mouse scrolling or movement events, touch screen and/or stylus inputs, game controller or other controllers associated with particular applications, keyboard keystrokes or combinations of keystrokes, device function buttons on a computing device chassis or a peripheral (e.g., printer, scanner, monitor), microphone/voice commands, camera-based input including facial recognition, facial expressions, or gestures, fingerprint and/or other biometric input, and/or any other suitable input initiated by a user to cause operations by a computing device. Input detector 202 can be implemented to monitor user activity and detect various inputs and/or combination of inputs that trigger power management.

Step 302 filters user inputs to categorize the detected user input for power management. For example, different inputs and/or combinations of inputs can be associated with different power states 208. These power states can be defined for individual components and/or as device-wide states. Filtering can be performed via a filter module 204 to match detected inputs to associated power states 208. In one approach, inputs and/or combinations of inputs can be categorized in broad categories designated for inputs that cause no change, inputs for which power is boosted, and/or inputs for which power is reduced. In an embodiment, inputs that are not associated with power state changes can be filtered out by the filter module 204 to avoid unnecessary processing.

In another approach, a hierarchy of multiple granular levels for power states can also be established and matched to various inputs. For example, power states can be established on a scale of power output percentages, such as a scale that is graduated in 10% increments. In other examples, the hierarchy of power states can be configured according to a numeric scale from 1 to 10 or in other designated groups arranged to relate to different power states of a device and/or components of the device. Any other suitable arrangement of different power states into which inputs and/or combinations of inputs can be categorized can also be employed. Further details regarding example filtering that can be performed to categorize inputs can be found below in the section titled “Filtering Inputs.”

Step 304 selects a power state for the computing device corresponding to the filtered input. For instance, a power state can be selected based on the filtering that is performed in step 302. This can occur via the state manager 206. In general, the power state is selected to match the user input that is detected. Thus, for low intensity operations, a relatively low power state can be selected. For more intense operations, a high power state can be selected.

Step 306 operates the computing device using the selected power state during user activity. For instance, power manager module 112 can operate to implement the power state that is selected in step 304. This can include boosting power or reducing power as appropriate for particular inputs and corresponding activities. For instance, a power state change can be tied to a particular user activity corresponding to the input that is initiated the power state change. By way of example, web browsing activities can cause a power boost designated for web browsing, while an email activity can cause a different type or level of power state change. On the other hand, reading a digital book locally or viewing a picture library may cause a power reduction since responsiveness can be deemed less important for these activities. Thus, various different kinds of inputs and activities can cause the power manager module 112 to make different changes to power states of a computing device 102. The power state change can persist until the user activity is completed, at which point another power state change can occur.

Accordingly, step 308 transitions to a different power state responsive to completion of the user activity or after a period of time, such as a pre-determined period of time. This can involve returning to a previous state and/or entering a “normal” operation mode. The transition can occur in response to a determination that user activity associated with the input is completed. In at least some embodiments, further user action can be used to determine when user activity has been completed. For example, a user can provide additional inputs to close a window, select an exit button, switch applications, and so forth. In another example, a period of inactivity can trigger a power state transition to a normal mode or other designated power state.

In addition or alternatively, the power state change can be configured to last for a designated interval that can be defined in various ways. For example, the interval can be defined to correspond to a period of time, an amount of energy consumption, and/or other criteria suitable to set an interval for operating in a selected state. Different intervals can also be associated with different user activities. Users may also be provided with options to configure intervals for different activities, inputs, types of activities, and/or types of power management. Accordingly, user input can cause a power state change that is associated with a designated interval. When the designated interval for the power state change passes, the state manager 206 can operate to transition to another state or otherwise conclude the power state change that was made.

Certain parameters (e.g., device utilization) can be observed during the designated interval and can be provided to the state manager at the end of the interval to facilitate a determination regarding a state transition. For example, if the device utilization during the designated interval is lower than a predefined threshold, this can indicate that corresponding user-initiated operations are not latency-sensitive. In this case, running in a high power state may not result in a user detectable change in responsiveness. Accordingly, the state manager can decide to drop to a lower power state.

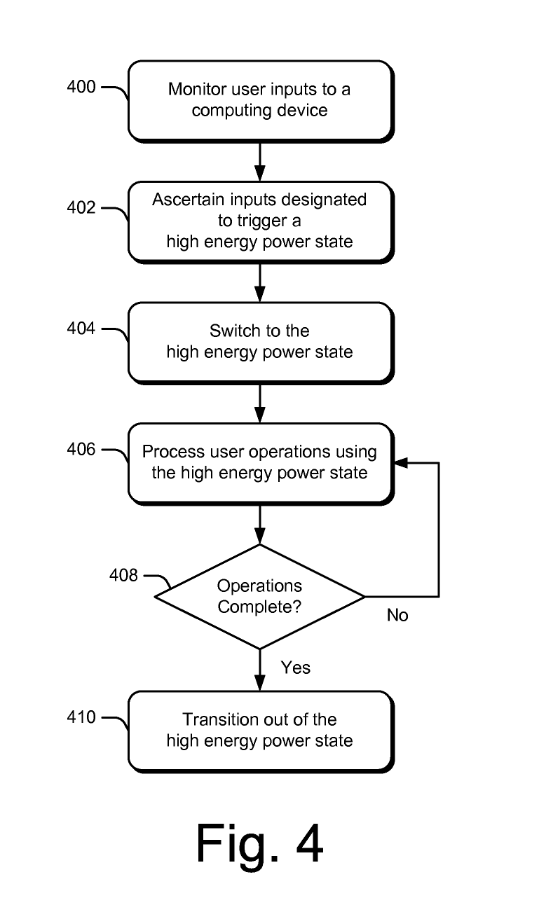

To illustrate some further details regarding techniques for user input triggered device power management, consider now FIG. 4 which illustrates another example method. In particular, FIG. 4 depicts a method in accordance with one or more embodiments in which user input can trigger a boost in power to a high power state.

Step 400 monitors user input to a computing device and, based on this monitoring, step 402 ascertains inputs designated to trigger a high power state. The monitoring can occur through an input detector 202 provided by a power manager module 112 as noted previously. When inputs are detected, various filtering can occur to classify the inputs and determine inputs that are defined to trigger a power boost to a high power state. It should be noted that comparable filtering can also be used in some user input scenarios to determine when a power reduction to a low power state is triggered. Some example implementation details regarding filter techniques are discussed in the following section.

Filtering Inputs

Filtering of inputs can occur in various ways to classify inputs. The filtering can be based on a hierarchy, table, or other suitable input filtering data structure that is configured to match different inputs and/or corresponding activities to a plurality of available power states. The power manager module 112 can react to various inputs by setting one or more power manageable components 114 to power states established for the components by the hierarchy, table, or other suitable input filtering data structure.

Spurious or unnecessary triggering of higher energy consumption and increased responsiveness can be prevented or reduced by intelligently filtering the array of user inputs. For instance, various possible user inputs can be matched to different categories that provoke different algorithmic responses and corresponding power state selections using any suitable type of input filtering data structure. The input filtering data structure can be configured to cause the system to react to different inputs in different ways. More particularly, an input filtering data structure can be defined to control whether different inputs cause different power management options such as a boost in power state, a reduction in power state, and/or no change in power state. In general, power can be boosted for user activities in situations when responsiveness is deemed relatively important, and can be reduced when responsiveness may be considered less important. The filtering as just described provides a mechanism to determine whether or not responsiveness is deemed important for different inputs and/or corresponding user activities.

For example, in a typing scenario (keyboard input), the alphabetic, numeric, and punctuation keys may be deemed less likely to start a significant user activity than the enter, escape, function, or arrow keys. As such, the former keystrokes can be filtered and/or placed into a category of user input that does not trigger a high power state. On the other hand, the latter keystrokes can be configured to cause a boost to a high power state. As another example, a mouse keydown event (the first part of “clicking”) may be deemed less likely to start operations when compared to a keyup event (the second part of “clicking”). Accordingly, the keydown event and keyup events can be classified to cause different corresponding power state selections.

Various algorithms to facilitate filtering inputs and setting power states can be defined and employed. These algorithms can include both static and dynamic approaches. In a static approach, an input filtering data structure as discussed above can include a set of predefined inputs that are matched to power states. When inputs and/or combinations are not associated with a change in power states, these inputs can simply be filtered out. Other inputs can be associated with different power states and therefore can cause corresponding selective switching between power states when detected by the power manager module 112.

Another approach involves dynamically adjusting the filtering data structure at run time based on online characterization of different user inputs. In other words, the matching of inputs to different power states can be adjusted dynamically based on feedback from one or more computing devices 102, a community of users, historical data, and/or other feedback that can assist in determining when to boost power and responsiveness. In this approach, a predefined list of inputs can be provided as an initial or default list that can be adjusted using various user specific and/or collective feedback regarding the various inputs.

Some examples of feedback that can be used to dynamically adjust filtering include but are not limited to the frequency of specific user inputs, correlation between user inputs and component usage demands, and an assessment of a power and performance tradeoff. For example, frequency of specific user inputs can be used to eliminate infrequent inputs that may not provide noticeable responsiveness gains and therefore are not considered good triggers. On the other hand, very frequent inputs may be tied closely to activities that a particular user engages in often and therefore may be good candidates for power boosting.

Filtering can also be adjusted based on a correlation between user inputs and component usage demands. For example, some inputs can be correlated to very large amounts of CPU usage. Filtering can be set to filter out or ignore these inputs because separate CPU processing power management algorithms are typically already in place to respond to CPU load increases by gradually or immediately moving to high power states. On the other end of the spectrum, inputs correlated to tiny amounts of CPU usage can also be ignored because the potential improvement in responsiveness is relatively small.

A power and performance tradeoff assessment can also be used to determine which inputs make good triggers for boosting power. A measurement or estimation of energy consumption versus the performance gain and/or cost of changing between power states can be obtained in various ways. This can occur through power performance modeling and/or testing, analysis of individual devices and users, collection and analysis of historic operational data from multiple users and computing devices and so forth. In some instances, a power and performance tradeoff assessment can be made available online. Accordingly, the power manager module 112 can access and make use of the assessment to inform filtering decisions and/or adjust filtering algorithms if appropriate.

For example, using the assessment, filtering can be set to filter out or otherwise ignore inputs that consume significantly more energy for limited gains in performance or responsiveness. Conversely, inputs for which performance improves significantly at high power states with relatively small or insignificant additional energy consumption can be selected as candidate inputs for triggering a power boost. Various combinations of the foregoing filtering approaches can also be employed.

Filtered inputs that are obtained using the techniques just described can be used to set power states accordingly. Thus, when a triggering input to boost power is determined in step 402, step 404 switches to the high power state. For example, the power manager module 112 can be configured to respond to different triggering inputs by selecting and/or otherwise causing a switch to a corresponding power state 208. The transition to a triggered power state can occur in various ways. Further, the amount of power increase or level of a power boost, as well as the particular power manageable components 114 selected for boosting, can be designated in different ways and/or individually for different inputs. Some example techniques and implementation details regarding responding to a triggered power state are provided in the following section.

Responding to Triggered States

In general, inputs that precede user operations for which responsiveness is user-perceivable and deemed relatively important can be configured to trigger high power states (e.g., “boosting” a device's performance). A power boost can be global for an entire device or for one or more selected components of a device. Various approaches can be used to control when to trigger a high power state and/or the amount/level of the power boost that occurs.

For example, static approaches can be used to boost power to a predefined power level. In a straightforward approach, each triggering user input can cause a boost to a predefined power level. The predefined power level can be designated as a global setting that applies to each triggering user input. In at least some implementations, the predefined level can correspond to a maximum power setting. In addition or alternatively, different power levels can be designated individually for different triggering user inputs. For instance, a hierarchy of multiple different power levels can be established for a device as mentioned previously.

By way of example, a device may be configured to support ten different power levels that can be associated with and triggered by different user inputs. Different power levels can include a normal or default level, some “boosted” levels corresponding to higher energy-consumption states, and some “reduced” levels corresponding to reduced energy-consumption states. In a particular example arrangement that makes use of numeric level designators, level 5 can be defined as a normal level, levels 6-10 can correspond to boosted levels, and levels 1-4 can correspond to reduced levels. Here, any of the boosted levels 6-10 can be designated as a global setting for power boosts and/or on an individual basis for different triggering user inputs configured to cause power boosts. Naturally, a hierarchy of multiple different power levels can be arranged and designated in any suitable way, of which the foregoing is but one illustrative example.

In another example approach, a triggering user input can be configured to change to a maximum device performance state determined for the particular device. In this approach, modeling can be employed to pre-determine ratios of performance to energy consumption for different power levels, power manageable components, and/or activities. Modeling can be used to determine an “optimal” power/performance state that can be designated as a global power setting. Optimal power/performance states can also be determined and designated for different triggering events based on the modeling, such that each triggering input is configured to cause a switch to an optimal power/performance state predetermined on an individual basis for different user inputs.

For devices with multiple power manageable components, the approach taken to controlling transitions to different state can be more complex. In various embodiments, different power manageable components can be transitioned as a whole, in designated groups or subsets of components, and/or individually. Consider for example power management for multi-core processors. When a user input triggers a power boost, the frequencies of each of the multiple cores can be increase collectively to boost responsiveness for the device as a whole. Another technique is to increase the frequencies of a selected subset of cores that correspond to the trigger, such as boosting selected cores that will be processing the particular user input or performing the resulting operation(s). In some instances, this can involve increasing the frequency of one or more of the processing cores that are running in a foreground thread. Dependencies between the frequencies of different cores can be taken into account to select a subset of cores to boost for a given triggering user input. Additionally, if some cores are “parked” so that they are unavailable for normal task processing, additional cores can be un-parked to handle the operation load increase that is expected in connection with the power boost.

In some embodiments, dynamic approaches can be employed. For instance, an optimal power/performance state can be determined dynamically at run-time (e.g., in response to a triggering user input) based on the workload and hardware characteristics of a particular device. Runtime analysis can be used to determine situations in which a power boost may not provide a significant increase in responsiveness for a given triggering user input. For example, a higher processor frequency may not improve the responsiveness of an IO-bound or memory-bound operation, but it still increases the energy consumption. Runtime analysis of workload characteristics can detect such situations and adjust algorithmic responses accordingly.

In another example, multiple power manageable components can be managed dynamically using profile data for components and inputs that may be collected and made available online. Profile data can be collected from multiple devices and users. In general, the profile data for particular inputs and components describes responses that are expected by the components when the particular inputs occur. This can include indications regarding whether a component is associated with a particular input, whether the load on the component is increased or decreased, interrelations between different components and/or inputs, and so forth. For example, the number of cores to be un-parked for a multi-core system can be determined dynamically based on online profiling that indicates whether or not the current user input will cause an operational load increase for the multi-core system.

Accordingly, various approaches can be employed to select and switch to a high power state to boost power and responsiveness. When the power state is boosted, step 406 processes user operations using the high power state. Here, the boosted power level that is applied to implement the high power state is used to complete various activities. Since the power level is boosted, the device may exhibit more responsiveness thereby improving the overall user experience when engaged in the activities.

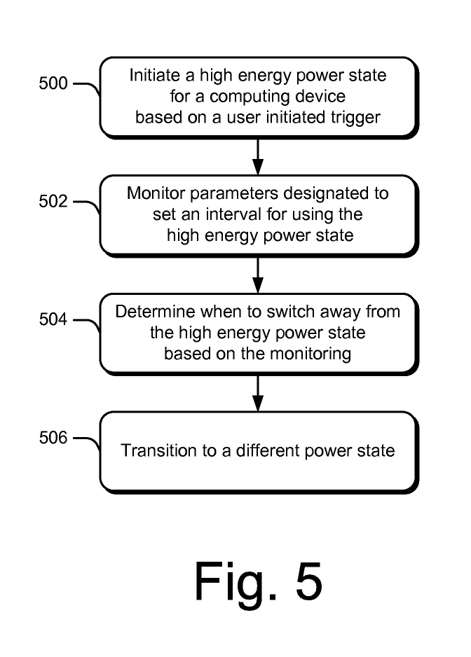

At other times, when responsiveness is deemed less important, the power level can be returned to normal and/or can otherwise be reduced to conserve energy and/or prolong battery life. In order to decide when to transition out of a boosted state, step 408 makes a determination regarding whether the user operations are completed. If the operations are not yet complete, the procedure returns to step 406 where processing of user operations using the high power state continues. At some point, the determination in step 408 determines that user operations are complete. At this point, step 410 transitions out of the high power state. This can involve returning to a state preceding the triggering user input or another defined power state. In some instances, the power can be boosted further to an even higher or maximum power state if appropriate. The state manager 206 can handle determining when to transition and what state to transition to using various approaches. Some example techniques and implementation details regarding transitioning out of a triggered state are provided in the following discussion of another example method depicted in FIG. 5.

Referring to FIG. 5, another example method is depicted in which various parameters can be employed to determine when to conclude using a high power state. When one or more devices have been transitioned to a high power and more responsive state, the devices can be returned to “normal” power management operation after a designated interval. Likewise, a comparable switch can occur after a designated interval in cases where a device has been transitioned to a lower power-consumption state. The intervals employed for these transitions can be determined using a variety of suitable techniques. Note that the selected intervals employed to transition out of a power state change may be different for different devices, power levels, different directions of power changes, and so forth.

Step 500 initiates a high power state for a computing device based on a user initiated trigger. For example, various user inputs can be detected by an input detector 202 as previously discussed. The inputs can cause the state manager 206 to implement a boost to a high power state.

While in the boosted state, monitoring can occur to determine when to conclude using the high power state. In particular, step 502 monitors parameters designated to set an interval for using the high power state. Then, step 504 determines when to switch away from the high power state based on the monitoring. For example, the state manager 206 can be configured to perform monitoring to determine when to make a switch between states. This can occur for example when an interval defined for the high power state passes. Various parameters can be monitored to make this determination. For example, a timer configured to run for a pre-determined time interval can be monitored. In another example, energy consumption can be monitored to ascertain when a energy consumption value that defines the interval has been reached. In yet another example, further user inputs and activities can be monitored and used to decide when an interval for the boosted state is complete.

When an appropriate determination is made to switch away from the high power state, step 506 transitions to a different power state. The state manager 206 can implement different techniques to select or otherwise determine an appropriate state to switch to and cause the transition to the determined state. The transition out of a particular state to a different state can be configured to occur to various suitable states associated with a device. Additional implementation details regarding suitable states for transitions and parameters that can be monitored are provided in the following section.

Transitioning out of a Triggered State

Various example techniques can be employed for transitioning between states. In at least some embodiments, users can be provided with options to select various power management options including settings for transitions between states. This can occur through a power management user interface that is output via the power manager module 112.

In at least some embodiments, state transitions can be designated in a static manner. For example, a transition from a boosted state (or a reduced state) can be predefined to occur back to a “normal” or “default” power state. Similarly, the transition can be defined to occur back to a preceding power state. In another approach, the transition can be predefined to occur to an intermediate power state somewhere between the previous state and the boosted state (or reduced state).

Still further, various user configurable management options can enable users to selectively designate a power management scheme to control power state transitions. This can include selecting between different schemes that provide different options for more or less aggressive approaches to balancing power management and performance/responsiveness.

The particular scheme that is selected can therefore control the manner in which states are switched. The state manager can operate to identify a selected power management scheme and perform transitions between states in accordance with the selected power management scheme. In general, a more aggressive performance biased scheme may boost power to relatively higher power levels than a less aggressive scheme. Likewise, a more aggressive energy biased scheme can be configured to switch back to relatively lower power levels (e.g., intermediate levels) than a more aggressive scheme.

Moreover, the interval that controls how long a boosted or reduced state remains active can also be set in various ways. In one example, a fixed interval of time can be employed to set the interval for a transition between states. For instance, the interval can be set to a designated number of milliseconds after the triggering user input. Thus, a boosted state can remain active for the designated number of milliseconds after which a transition to another state can occur. In another approach, a transition between boosted and normal states can be configured to occur according to a designated amount of energy consumption for a boosted state or a reduction in energy consumption for reduced states.

Dynamic approaches to setting an interval for a boosted or reduced state can also be employed. For instance, an interval can be computed dynamically based on run-time analysis of the typical operation length associated with the triggering input or activity. Similarly, run-time analysis of the triggering input or activity can be used to determine an appropriate power management scheme, which can then be automatically selected and/or recommended to the user. Thus, the interval can be tailored to the particular triggering input or activity, such that different intervals may be used with different inputs and activities.

Another example involves transitioning out of the boosted state when the system (or subset of system devices used in performing the operation) becomes “idle.” In some case, returning to a preceding or normal state based on “idleness” may not make sense, such as when a return to a boosted state is expected to occur shortly. For example, if there are multiple phases of activity with embedded “idle” conditions, simply reacting to the “idle” conditions by switching to a preceding or normal state may not be optimal. An example of this type of situation is when a processor has sent out network packets and is waiting to receive response packets before continuing with further operations. In this case, if the system is returned all the way back to a normal state for an idle condition, the subsequent response when the network packets return may not occur in a sufficiently responsive manner. In these types of situations, an intermediate state and/or moderately aggressive scheme may be designated to intelligently control the transition and prevent the “idle” interval from causing a complete return to the preceding or normal state. This approach can improve the responsiveness of subsequent activities.

Having considered example techniques for user input triggered device power management, consider a discussion of an example system in accordance with one or more embodiments.

Example System

FIG. 6 illustrates an example system generally at 600 that includes an example computing device 602 that is representative of one or more such computing systems and/or devices that may implement the various embodiments described above. The computing device 602 may be, for example, a server of a service provider, a device associated with the computing device 102 (e.g., a client device), an on-chip system, and/or any other suitable computing device or computing system.

The example computing device 602 includes one or more processors 604 or processing units, one or more computer-readable media 606 which may include one or more memory and/or storage components 608, one or more input/output (I/O) interfaces 610 for input/output (I/O) devices, and a bus 612 that allows the various components and devices to communicate one to another. Computer-readable media 606 and/or one or more I/O devices may be included as part of, or alternatively may be coupled to, the computing device 602. The bus 612 represents one or more of several types of bus structures, including a memory bus or memory controller, a peripheral bus, an accelerated graphics port, and a processor or local bus using any of a variety of bus architectures. The bus 612 may include wired and/or wireless buses.

The one or more processors 604 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 608 represents memory/storage capacity associated with one or more computer-readable media. The memory/storage component 608 may include volatile media (such as random access memory (RAM)) and/or nonvolatile media (such as read only memory (ROM), Flash memory, optical disks, magnetic disks, and so forth). The memory/storage component 608 may include fixed media (e.g., RAM, ROM, a fixed hard drive, etc.) as well as removable media (e.g., a Flash memory drive, a removable hard drive, an optical disk, and so forth).

Input/output interface(s) 610 allow a user to enter commands and information to computing device 602, and also allow information to be presented to the user and/or other components or devices using various input/output devices. Examples of input devices include a keyboard, a cursor control device (e.g., a mouse), a microphone, a scanner, an infrared sensor, camera, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” may refer to a signal bearing medium that is configured to transmit instructions to the hardware of the computing device, such as via the network 112. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the power manager module 112, operating system 108, applications 110, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 602 may be configured to implement particular instructions and/or functions corresponding to the software and/or hardware modules implemented on computer-readable media. The instructions and/or functions may be executable/operable by one or more articles of manufacture (for example, one or more computing devices 602 and/or processors 604) to implement techniques for user input triggered device power management, as well as other techniques. Such techniques include, but are not limited to, the example procedures described herein. Thus, computer-readable media may be configured to store or otherwise provide instructions that, when executed by one or more devices described herein, cause various techniques for user input triggered device power management.

### CONCLUSION

Techniques for user input triggered device power management are described that enable user inputs and activities to cause selective changes in power states for a device. Power can be boosted to a high power state to improve responsiveness for designated inputs and/or activities. When responsiveness is deemed less important in connection with particular inputs and/or activities, a low power state can be set to reduce energy consumption. In at least some embodiments, selectively switching between power states includes detecting various user inputs at a device and filtering the inputs to select power states associated with the user inputs. The device can then be operated in a selected power state until a transition to a different power state is triggered by occurrence of designated events, such as running of a set time interval, further user input, and/or completion of user activity.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
detecting user input at a computing device;
filtering to categorize the detected user input for power management of the computing device;
selecting a power state corresponding to filtered input; and
operating the computing device using a selected power state during user activity initiated by the user input.

2. The computer-implemented method of claim 1, further comprising:
transitioning to a different power state responsive to completion of the user activity.

3. The computer-implemented method of claim 1, further comprising transitioning to a different power state responsive to passing of an interval configured to control how long the computing device remains in the selected power state.

4. The computer-implemented method of claim 3, wherein the interval is based upon an amount of energy consumed in the selected power state.

5. The computer-implemented method of claim 3, wherein the interval comprises a predetermined interval of time.

6. The computer-implemented method of claim 1, wherein the selected power state comprises a high power state configured to boost responsiveness during the user activity.

7. The computer-implemented method of claim 1, wherein the selected power state comprises a low power state configured to reduce energy consumption during the user activity.

8. The computer-implemented method of claim 1, wherein the filtering comprises ascertaining a power state corresponding to the user input based on an input filtering data structure configured to match different user inputs to different power management options.

9. The computer-implemented method of claim 1, wherein the selected power state is associated with the detected user input on an individual basis.

10. The computer-implemented method of claim 1, wherein the selected power state is configured to apply component-specific power state changes to one or more power manageable components of the computing device.

11. A computer implemented method comprising:
ascertaining user inputs designated to trigger a high power state for a device;
on the device, switching to the high power state in accordance with the ascertained user inputs to process user operations;
determining when to switch away from the high power state; and
transitioning out of the high power state to a different power state.

12. The computer implemented method of claim 11, wherein determining when to switch comprises monitoring one or more parameters designated to set an interval for using the high power state.

13. The computer implemented method of claim 11, wherein determining when to switch comprises monitoring to detect further user input that triggers a transition out of the high power state.

14. The computer implemented method of claim 11, wherein transitioning out of the high power state comprises transitioning to a default power state defined for the device or a previous power state.

15. The computer implemented method of claim 11, wherein transitioning out of the high power state comprises:
identifying a user configurable power management scheme selected to control transitions between power states and associating the different power state with the ascertained user inputs; and
setting the computing device to the different power state in accordance with the identified power management scheme.

16. The computer implemented method of claim 11, wherein the different power state comprises a state that boosts responsiveness of the computing device to a higher level than the high power state.

17. One or more computer-readable storage media storing instructions that, when executed via a computing device, implement an power manager module for managing power states of the computing device, the power manager module configured to:
monitor one or more parameters configured to set an interval for a selected power state that is set for the computing device based at least in part upon detection by the power manager module of user inputs that trigger the selected power state;
determine when to switch away from the selected power state based on the monitoring; and
transition to a different power state.

18. One or more computer-readable storage media of claim 17, wherein the different power state is determined in accordance with a user configurable power management scheme selected for the computing device.

19. One or more computer-readable storage media of claim 17, wherein the one or more parameters that are monitored include a timer configured to run for a pre-determined time interval, energy consumption of the computing device in the selected power state, and further user input that indicates when to transition out of the selected power state.

20. One or more computer-readable storage media of claim 17, wherein the power manager module is further configured to initiate the selected power state to boost responsiveness for activities associated with the user inputs responsive to the detection of the user inputs by the power manager module.
